(19) United States
(12) Patent Application Publication
(10) Pub. No.: US 2021/0284099 A1
(43) Pub. Date: Sep. 16, 2021

(54) DOOR FOR VEHICLE

(71) Applicants: TOYOTA JIDOSHA KABUSHIKI KAISHA, Aichi (JP); SUBARU CORPORATION, Tokyo (JP)

(72) Inventors: Masami UEHATA, Toyota-shi (JP); Sho TSUMITA, Toyota-shi (JP); Mitsuru FUKUSHIMA, Tokyo-to (JP); Naoyuki OTA, Kariya-shi (JP)

(21) Appl. No.: 17/176,182

(22) Filed: Feb. 16, 2021

(30) Foreign Application Priority Data
Mar. 10, 2020 (JP) 2020-041301

(51) Int. Cl. B60R 25/24; H01Q 1/32; B60J 5/04; B60R 13/04; B60J 1/08

(52) U.S. Cl. CPC B60R 25/245; H01Q 1/3283; B60J 1/08; B60R 13/04; B60J 5/0402

(57) ABSTRACT

The disclosure herein provides a door for a vehicle in which an antenna is arranged such that signal waves from a device outside the vehicle are favorably received and effects of in-vehicle noise waves are diminished. A door for a vehicle may include: a window frame surrounding a window glass and including a vertical plate extending along a side edge of the window glass; an outer garnish constituted of resin and covering the vertical plate from outside of the vehicle; and an antenna arranged between the outer garnish and the vertical plate. The resin outer garnish allows radio waves to pass therethrough well, thus the antenna can favorably receive the radio waves. On the other hand, the vertical plate of the window frame is constituted of metal, and hence radio waves are less likely to pass therethrough.

### CROSS-REFERENCE TO RELATED APPLICATION

This application claims priority to Japanese Patent Application No. 2020-041301 filed on Mar. 10, 2020, the contents of which are hereby incorporated by reference into the present application.

### TECHNICAL FIELD

The technology disclosed herein relates to a door for a vehicle. More particularly, the technology relates to a door in which an antenna is incorporated.

### BACKGROUND

A vehicle includes an antenna to receive radio waves outside the vehicle. In order to favorably receive the radio waves outside the vehicle, the antenna is arranged near a glass that allows the radio waves to pass therethrough. Alternatively, such an antenna is arranged on a roof, as disclosed in Japanese Patent Application Publication No. 2011-182280, for example. The antenna is desirably unaffected by in-vehicle noise waves. Japanese Patent Application Publication No. 2011-182280 describes a technology of diminishing effects of in-vehicle noise waves by combining the antenna with a noise suppression circuit.

### SUMMARY

The disclosure herein provides a door for a vehicle in which an antenna is arranged such that signal waves from a device outside the vehicle are favorably received and effects of in-vehicle noise waves are diminished.

A door for a vehicle disclosed herein may comprise a window frame surrounding a window glass, an outer garnish constituted of resin, and an antenna. The window frame may include a vertical plate extending along a side edge of the window glass. The outer garnish may cover the vertical plate from outside of the vehicle. The antenna may be arranged between the outer garnish and the vertical plate. The resin outer garnish allows radio waves to pass therethrough, thus the antenna can favorably receive the radio waves outside the vehicle. On the other hand, the vertical plate of the window frame is constituted of metal, and hence radio waves are less likely to pass therethrough. The above-described antenna arrangement can diminish effects of in-vehicle noise waves on the antenna.

The door may comprise a hinge configured to open/close the door. The window glass may include a first side edge and a second side edge, and the first side edge may be closer to the hinge than the second side edge. The antenna may be arranged between the outer garnish and the vertical plate extending along the first side edge. Such an arrangement can decrease an impact applied to the antenna when the door is opened or closed. The antenna may be arranged above a center of the vertical plate in an up-down direction. This makes the antenna less likely to be affected by moisture.

Details and further improvements of the technique disclosed herein will be described in Detailed Description below.

### BRIEF DESCRIPTION OF DRAWINGS

FIG. 1 is a side view of a vehicle.

FIG. 2 is a cross-sectional view along a line II-II in FIG. 1.

FIG. 3 is the cross-sectional view with an outer garnish detached from a door.

### DETAILED DESCRIPTION

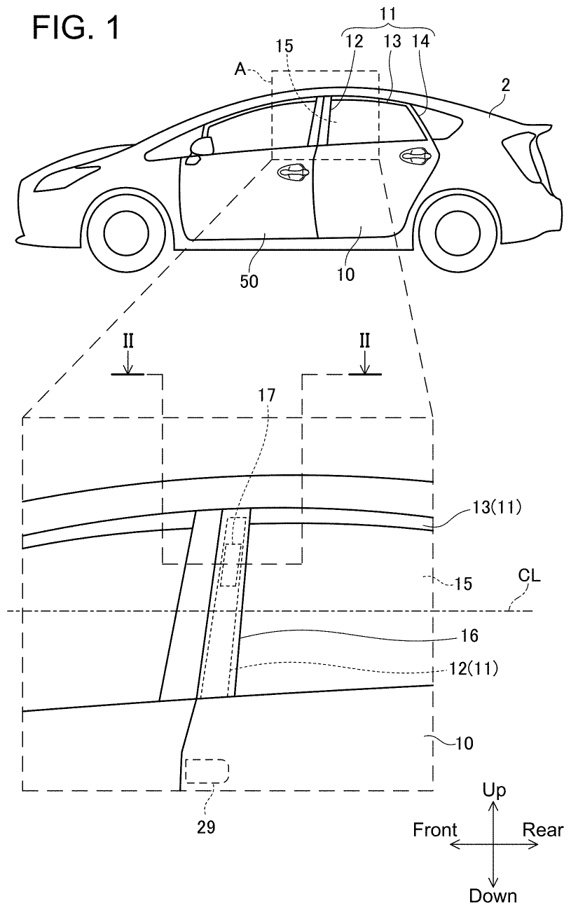

With reference to the drawings, a door 10 according to an embodiment will be described. The door 10 is a door for a left rear seat of a vehicle 2. FIG. 1 shows a left side view of the vehicle 2. The lower diagram in FIG. 1 shows an enlarged view of an area A.

The door 10 includes a window frame 11 surrounding a window glass 15. The window frame 11 is configured of an upper plate 13 facing an upper edge of the window glass 15 and a pair of vertical plates 12, 14 each extending along corresponding one of side edges of the window glass 15. The upper plate 13 extends in a vehicle front-rear direction, and the vertical plates 12, 14 extend in an up-down direction. The vertical plate 12 is located closer to a hinge 29 configured to open/close the door 10 than the vertical plate 14. The vertical plate 12 faces a center pillar 4 (which will be described later) of the vehicle 2.

The vertical plate 12 is covered by an outer garnish 16 constituted of resin. In a space between the outer garnish 16 and the vertical plate 12, an antenna 17 is arranged, which will be described later in detail. The antenna 17 is configured to receive radio waves from a smart key used to lock/unlock the door. In FIG. 1, a line CL passes through a center of the vertical plate 12 in the up-down direction. The antenna 17 is arranged above the center of the vertical plate 12 in the up-down direction (the line CL). In FIG. 1, a reference sign 50 indicates a door for a front seat.

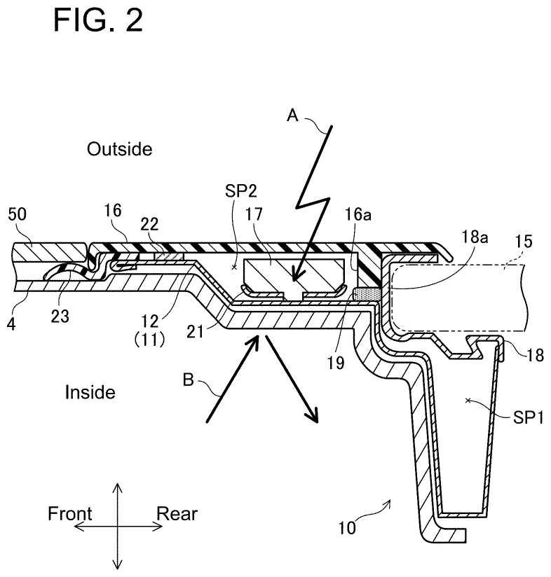

FIG. 2 shows a cross section along a line II-II in FIG. 1. The cross section of FIG. 2 is obtained by cutting the vertical plate 12 and the outer garnish 16 along a horizontal plane passing through the antenna 17. FIG. 2 also depicts a part of the center pillar 4 and a part of the door 50 for the front seat. The vertical plate 12 of the window frame 11 faces the center pillar 4.

A sash 18 is fixed to the vertical plate 12. The sash 18 is a channel-shaped beam extending in the up-down direction and is fitted to the side edge of the window glass 15 along which the vertical plate 12 extends. The sash 18 may also be called a glass run channel. FIG. 2 depicts the window glass 15 by a phantom line. Although a weather strip is arranged in the sash 18, its depiction is omitted.

The resin outer garnish 16 covers and hides the metal vertical plate 12 and the sash 18 from the outside of the vehicle to improve the outer appearance around the edge of the window glass.

The outer garnish 16 includes a rib 16a on its back surface. The term “back surface” means a surface oriented to the inside of the vehicle. The rib 16a is in contact with a bottom plate 18a of the sash 18 (a bottom plate 18a of the channel shaped sash 18). A back side of a front end of the outer garnish 16 is bonded to the vertical plate 12 with a double-sided tape 22. A clearance surrounded by a distal end of the rib 16a of the outer garnish 16, the vertical plate 12, and the sash 18 is filled with a sealant 19. The sealant 19 blocks entry of water from a first space SP1 surrounded by the sash 18 and the vertical plate 12 into a second space SP2 in which the antenna 17 is arranged.

The sealant 19 is a formed-in-place gasket (FIPG) mainly constituted of rubber foam and is originally a gel. The FIPG solidifies when exposed to air, and functions as a gasket. The originally gelatinous sealant 19 also functions as an adhesive, and a rear portion of the outer garnish 16 is fixed to the vertical plate 12 and the sash 18 with the sealant 19.

A weather strip 23 constituted of rubber is attached to the front end of the outer garnish 16. The weather strip 23 blocks entry of water into the vehicle from a clearance between the door 50 for the front seat and the door 10 for the rear seat.

The back surface of the outer garnish 16 includes the rib 16a. The rib 16a extends in the up-down direction. The rib 16a provides the following advantages.

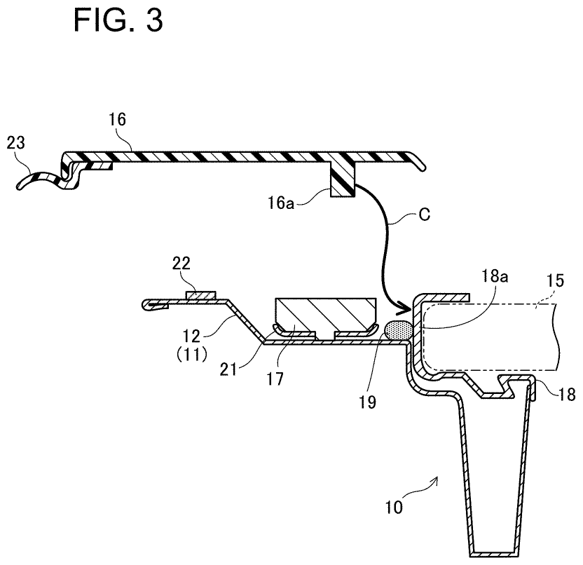

FIG. 3 shows the cross-sectional view with the outer garnish 16 separated from the door 10. When the outer garnish 16 is to be attached, the rib 16a is pressed against the bottom plate 18a of the sash 18 as shown by a bold arrow C in FIG. 3, with the double-sided tape 22 and the sealant 19 (in form of gel) attached to the vertical plate 12. Pressing the rib 16a against the sash 18 enables the outer garnish 16 to be accurately positioned in the vehicle front-rear direction. Then, when the outer garnish 16 is pressed against the vertical plate 12, the sealant 19 is thereby compressed, as a result of which the clearance surrounded by the distal end of the rib 16a, the sash 18, and the vertical plate 12 is sealed. A front portion of the outer garnish 16 is fixed to the vertical plate 12 with the double-sided tape 22.

The rib 16a narrows the clearance occupied by the sealant 19 (the clearance between the distal end of the rib 16a and the vertical plate 12) and allows the clearance to be sealed firmly. Fixation of the outer garnish 16 using the double-sided tape 22 and the sealant 19 is easier than fixing it using a grommet.

Returning to FIG. 2, the antenna 17 will be described. As described above, the antenna 17 is arranged in the second space SP2 between the outer garnish 16 and the vertical plate 12. The antenna 17 is fixed to the vertical plate 12 with a bracket 21. The antenna 17 is configured to receive radio waves from the smart key. In FIG. 2, a bold arrow A schematically shows radio waves from the smart key outside the vehicle. The antenna 17 is isolated from the outside of the vehicle only by the outer garnish 16. The resin outer garnish 16 allows radio waves to pass therethrough well. The outer garnish 16 hides the antenna 17 without disturbing reception of radio waves outside the vehicle.

The antenna 17 is located outward of the metal vertical plate 12 in the vehicle. Furthermore, the antenna 17 is located outward of the metal center pillar 4 in the vehicle. In FIG. 2, a bold arrow B schematically shows in-vehicle noise waves. The in-vehicle noise waves are blocked by the center pillar 4 and the vertical plate 12, which are constituted of metal.

The antenna 17 is less likely to be affected by the in-vehicle noise waves. The second space SP2 in which the antenna 17 is arranged is sealed with the sealant 19. The sealant 19 prevents adhesion of water onto the antenna 17. As shown in FIG. 1, the antenna 17 is arranged above the center of the vertical plate 12 in the up-down direction. This feature also contributes to the protection of the antenna 17 from water.

The window glass 15 includes a first side edge and a second side edge, and the first side edge is closer to the hinge 29 than the second side edge. The vertical plate 12 extends along the first side edge. The vertical plate 14 extends along the second side edge. The antenna 17 is arranged at the vertical plate 12, which is closer to the hinge 29 (see FIG. 1) configured to open/close the door 10. Such an arrangement decreases an impact applied to the antenna 17 when the door is closed.

An electronic circuit connected to the antenna 17 may be a circuit configured to lock/unlock the door in accordance with radio signals transmitted from the smart key. The electronic circuit connected to the antenna 17 may be a circuit configured to judge whether the smart key is located outside the vehicle. The electronic circuit connected to the antenna 17 may be a circuit configured to process a security-related radio signal from the outside of the vehicle.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

What is claimed is:

1. A door for a vehicle, comprising:
a window frame surrounding a window glass and including a vertical plate extending along a side edge of the window glass;
an outer garnish constituted of resin and covering the vertical plate from outside of the vehicle; and
an antenna arranged between the outer garnish and the vertical plate.

2. The door of claim 1, wherein
the door further comprises a hinge configured to open/close the door,
the window glass includes a first side edge and a second side edge, the first side edge being closer to the hinge than the second side edge, and
the vertical plate is located along the first side edge.

3. The door of claim 1, wherein the antenna is arranged above a center of the vertical plate in an up-down direction.
